(19) United States
(12) Patent Application Publication
(10) Pub. No.: US 2019/0243044 A1
(43) Pub. Date: Aug. 8, 2019

(54) TRANSMISSION DECORATIVE LAMINATE, METHOD OF MANUFACTURING THE SAME, GLASS BASE MATERIAL WITH TRANSMISSION DECORATIVE LAMINATE

(71) Applicant: FUJIFILM Corporation, Tokyo (JP)

(72) Inventors: Rie TAKASAGO, Kanagawa (JP); Hiroshi INADA, Kanagawa (JP); Masaru YOSHIKAWA, Kanagawa (JP); Mitsuyoshi ICHIHASHI, Kanagawa (JP)

(73) Assignee: FUJIFILM Corporation, Tokyo (JP)

(21) Appl. No.: 16/390,024

(22) Filed: Apr. 22, 2019

Related U.S. Application Data
(63) Continuation of application No. PCT/JP2017/038577, filed on Oct. 25, 2017.

(30) Foreign Application Priority Data
Oct. 25, 2016 (JP) 2016-208595
Jan. 6, 2017 (JP) 2017-000965

(51) Int. Cl. G02B 5/30; G02B 1/02; G02B 1/06; G02B 1/08; B32B 17/10; C09K 19/02; C09K 19/58; C09K 19/38; G02F 1/1335

(52) U.S. Cl. CPC G02B 5/3016; G02B 1/02; G02B 1/06; G02B 1/08; G02F 2001/133543; C09K 19/0275; C09K 19/586; C09K 19/38; G02F 1/133528; B32B 17/10504

(57) ABSTRACT

An object of the present invention is to provide a transmission decorative laminate including a cholesteric liquid crystalline layer and capable of applying different visual effects on observation surfaces, and a method of manufacturing the same. Another object of the present invention is to provide a glass base material with a transmission decorative laminate.

Provided is a transmission decorative laminate including: a colored transparent base material; and a cholesteric liquid crystalline layer disposed on the base material, in which the cholesteric liquid crystalline layer includes two or more reflection regions having different selective reflection wavelengths, and the base material absorbs light at wavelengths which are the same as selective reflection wavelengths of two or more reflection regions.

### CROSS-REFERENCE TO RELATED APPLICATIONS

This application is a Continuation of PCT International Application No. PCT/JP2017/038577 filed on Oct. 25, 2017, which claims priority under 35 U.S.C. § 119(a) to Japanese Patent Application No. 2016-208595 filed on Oct. 25, 2016 and Japanese Patent Application No. 2017-000965 filed on Jan. 6, 2017. Each of the above applications is hereby expressly incorporated by reference, in its entirety, into the present application.

### BACKGROUND OF THE INVENTION

### 1. Field of the Invention

The present invention relates to a transmission decorative laminate, a method of manufacturing the same, and a glass base material with a transmission decorative laminate.

### 2. Description of the Related Art

A layer including a fixed cholesteric liquid crystalline phase (hereinafter, also referred to as a “cholesteric liquid crystalline layer”) is known as a layer having properties of selectively reflecting any one of right circularly polarized light or left circularly polarized light in a specific wavelength range. Accordingly, the cholesteric liquid crystalline layer is applied for various uses, and for example, applied for a display device for displaying images having partially different color tones (JP2009-300662A).

### SUMMARY OF THE INVENTION

Meanwhile, recently, there are various demands for decorative films capable of displaying specific images and the like, and for example, a transmission type decorative film (transmission decorative film) that is capable of visually recognizing a scene of the other side through the film, capable of visually recognizing a specific display from one side (front surface), and substantially not capable of visually recognizing the display from the other side (rear surface).

A liquid crystal display device disclosed in examples of JP2009-300662A mainly aims at displaying an image formed on a liquid crystal layer (image that can be obtained by including two or more regions having selective reflection wavelengths different from each other, in the cholesteric liquid crystalline layer) with a higher tone, and there is no research for an aspect in which the displayed image differs depending on an observation surface.

Therefore, an object of the present invention is to provide a transmission decorative laminate including a cholesteric liquid crystalline layer and capable of applying different visual effects on observation surfaces, and a method of manufacturing the same.

Another object of the present invention is to provide a glass base material with a transmission decorative laminate.

As a result of intensive studies for achieving the object described above, the inventors have found that the problem described above can be solved by adjusting an absorption wavelength of a base material on which a cholesteric liquid crystalline layer is disposed, and the present invention has been completed.

That is, the inventors have found that the object described above can be achieved with the following configurations.

(1) A transmission decorative laminate comprising: a colored transparent base material; and a cholesteric liquid crystalline layer disposed on the base material, in which the cholesteric liquid crystalline layer includes two or more reflection regions having different selective reflection wavelengths, and the base material absorbs light at wavelengths which are the same as selective reflection wavelengths of two or more reflection regions.

(2) The transmission decorative laminate according to (1), in which each of transmittances of the base material at the selective reflection wavelengths in the two or more reflection regions are all 30% or less.

(3) The transmission decorative laminate according to (1) or (2), in which the base material includes a region having a transmittance exceeding 30% in a wavelength range of 380 to 780 nm.

(4) The transmission decorative laminate according to any one of (1) to (3), in which the selective reflection wavelengths of the two or more reflection regions are different from each other by 30 nm or more.

(5) The transmission decorative laminate according to any one of (1) to (4), which is used for an advertising medium.

(6) A glass base material with a transmission decorative laminate, the glass base material comprising: a glass base material; and the transmission decorative laminate according to any one of (1) to (5) which is disposed on the glass base material.

(7) The glass base material with a transmission decorative laminate according to (6), which is used for a window glass.

(8) A method of manufacturing the transmission decorative laminate according to any one of (1) to (5), the method comprising: a step of forming a coating using a liquid crystal composition including a liquid crystal compound including a polymerizable group, and a chiral agent sensitive to light and capable of changing a helical pitch of a cholesteric liquid crystalline phase; a step of performing an exposure treatment on the coating in a pattern shape, with light to which the chiral agent is sensitive; a step of performing a heating treatment on the coating subjected to the exposure treatment and aligning the liquid crystal compound to be in a state of a cholesteric liquid crystalline phase; and a step of performing a curing treatment on the coating subjected to the heating treatment and forming the cholesteric liquid crystalline layer formed by fixing the cholesteric liquid crystalline phase.

According to the present invention, it is possible to provide a transmission decorative laminate including a cholesteric liquid crystalline layer and capable of applying different visual effects on observation surfaces and a method of manufacturing the same.

In addition, according to the present invention, it is possible to provide a glass base material with a transmission decorative laminate.

### BRIEF DESCRIPTION OF THE DRAWINGS

FIG. 1 is a cross section schematic view showing an example of an embodiment of a transmission decorative laminate of the present invention.

FIG. 2 shows each transmission spectrum of a blue right circular polarization reflection region and a green right circular polarization reflection region included in a cholesteric liquid crystalline layer in the transmission decorative laminate shown in FIG. 1.

FIG. 3 shows a transmission spectrum of a base material in the transmission decorative laminate shown in FIG. 1.

FIG. 4 is a schematic view for describing an operation of the transmission decorative laminate shown in FIG. 1.

FIG. 5 is a view of the transmission decorative laminate seen in an a direction in FIG. 4.

FIG. 6 is a view of the transmission decorative laminate seen in a b direction in FIG. 4.

FIG. 7 is a cross section schematic view showing an example of the embodiment of the transmission decorative laminate of the present invention.

FIG. 8 shows each transmission spectrum of a red right circular polarization reflection region and a green right circular polarization reflection region included in a cholesteric liquid crystalline layer in the transmission decorative laminate shown in FIG. 7.

FIG. 9 shows a transmission spectrum of a base material in the transmission decorative laminate shown in FIG. 7.

FIG. 10 is a schematic view for describing an operation of the transmission decorative laminate shown in FIG. 7.

FIG. 11 is a cross section schematic view showing an example of the embodiment of the transmission decorative laminate of the present invention.

FIG. 12 shows each transmission spectrum of a blue right circular polarization reflection region and a red right circular polarization reflection region included in a cholesteric liquid crystalline layer in the transmission decorative laminate shown in FIG. 11.

FIG. 13 shows a transmission spectrum of a base material in the transmission decorative laminate shown in FIG. 11.

FIG. 14 is a schematic view for describing an operation of the transmission decorative laminate shown in FIG. 11.

FIG. 15 is a schematic view for describing an example of a method of manufacturing a cholesteric liquid crystalline layer.

### DESCRIPTION OF THE PREFERRED EMBODIMENTS

Hereinafter, the present invention will be described in detail.

The description of configuration elements described below is performed based on the representative embodiments of the present invention, but the present invention is not limited to such embodiments.

In the present specification, a range of numerical values shown using “to” means a range including numerical values before and after “to” as a lower limit value and an upper limit value.

In this specification, a term “sense” used in a case of describing circularly polarized light means that the circularly polarized light is right circularly polarized light or left circularly polarized light. In a case where the light is seen so that the light travels towards the front side and a distal end of an electric field vector rotates clockwise according to passage of time, the sense of the circularly polarized light is defined as right circularly polarized light, and in a case where the distal end thereof rotates counterclockwise, the sense of the circularly polarized light is defined as left circularly polarized light.

In this specification, the term “sense” may be used for a twisted direction of a helix of a cholesteric liquid crystalline phase. Regarding selective reflection of the cholesteric liquid crystalline phase, in a case where the twisted direction of the helix of the cholesteric liquid crystalline phase (sense) is right, the right circularly polarized light is reflected and the left circularly polarized light is transmitted, and in a case where the sense is left, the left circularly polarized light is reflected and right circularly polarized light is transmitted.

In this specification, a term “(meth)acrylate” is a term representing both acrylate and methacrylate.

Visible light is light having wavelengths which are visually recognizable by a person among electromagnetic waves and indicates light in a wavelength range of 380 to 780 nm. Invisible light is light in a wavelength range less than 380 nm or a wavelength range exceeding 780 nm.

Although it is not limited to this, in the visible light, light in a wavelength range of 420 to 490 nm is blue light, light in a wavelength range of 495 to 570 nm is green light, and light in a wavelength range of 580 to 750 nm is red light.

Infrared light is electromagnetic waves in a wavelength range exceeding 780 nm and equal to or less than 1 mm. Ultraviolet light is light in a wavelength range more than 10 nm and equal to or less than 380 nm.

In this specification, the selective reflection wavelength is an average value of two wavelengths showing half value transmittance: T½ (%) shown with the following equation, in a case where a minimum value of transmittance of a target product (member) is set as Tmin (%).

T½=100−(100−Tmin)/2 Equation for acquiring half value transmittance:

<Transmission Decorative Laminate>

A transmission decorative laminate of the present invention is a transmission decorative laminate including: a colored transparent base material; and a cholesteric liquid crystalline layer disposed on the base material, in which the cholesteric liquid crystalline layer includes two or more reflection regions having different selective reflection wavelengths, and the base material absorbs light at wavelengths which are the same as selective reflection wavelengths of two or more reflection regions.

Hereinafter, the embodiment for carrying out the present invention will be described in detail with reference to the drawings. The drawing of the present invention is a schematic view and a relationship between thicknesses, a positional relationship, and the like of layers do not necessarily correspond to actual figures.

### First Embodiment

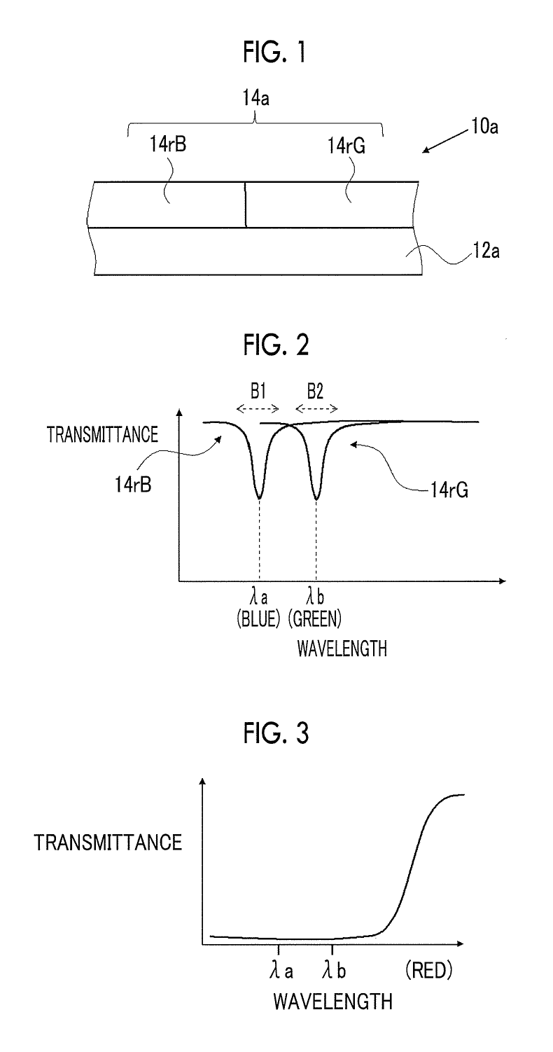

FIG. 1 is a cross section schematic view showing an example of the embodiment (First Embodiment) of the transmission decorative laminate of the present invention. A transmission decorative laminate 10a includes a base material 12a and a cholesteric liquid crystalline layer 14a disposed on the base material 12a.

The cholesteric liquid crystalline layer 14a is a layer formed by fixing a cholesteric liquid crystalline phase and includes two regions having helical pitches of the cholesteric liquid crystalline phase different from each other. More specifically, the cholesteric liquid crystalline layer 14a includes a blue right circular polarization reflection region 14rB which reflects right circularly polarized blue light and transmits left circularly polarized blue light and light in other wavelength ranges, and a green right circular polarization reflection region 14rG which reflects right circularly polarized green light and transmits left circularly polarized green light and light in other wavelength ranges. That is, in the cholesteric liquid crystalline layer 14a, the blue right circular polarization reflection region 14rB and the green right circular polarization reflection region 14rG are formed in a desired pattern.

Each of the blue right circular polarization reflection region 14rB and the green right circular polarization reflection region 14rG is formed by fixing a cholesteric liquid crystalline phase and has wavelength selective reflectivity with respect to right circularly polarized light in a specific wavelength range.

FIG. 2 shows transmission spectra of the blue right circular polarization reflection region 14rB and the green right circular polarization reflection region 14rG. The blue right circular polarization reflection region 14rB includes a selective reflection range B1 and the selective reflection wavelength thereof is shown as λa (nm). The selective reflection wavelength λa is positioned in a wavelength range of blue light. The green right circular polarization reflection region 14rG includes a selective reflection range B2 and the selective reflection wavelength thereof is shown as λb (nm). The selective reflection wavelength λb is positioned in a wavelength range of green light.

In general, a selective reflection wavelength λ depends on a pitch P (=period of helix) of a helical structure of the cholesteric liquid crystalline phase and is in a relationship of an average refractive index of the cholesteric liquid crystalline phase and λ=n×P. Accordingly, the selective reflection wavelength can be adjusted by adjusting the pitch of the helical structure. The pitch of the cholesteric liquid crystalline phase depends on the kind of a chiral agent used with a polymerizable liquid crystal compound or an added concentration thereof, and thus, a desired pitch can be obtained by adjusting these.

A half-width Δλ (nm) of the selective reflection range showing the selective reflection depends on a refractive index anisotropy Δn of the cholesteric liquid crystalline phase and a pitch P of the helix, and is in a relationship of Δλ=Δn×P. Accordingly, a width of the selective reflection range can be controlled by adjusting Δn. Δn can be adjusted in accordance with the kind of the liquid crystal compound forming the reflection region, a mixing ratio thereof, and a temperature during the alignment and fixing. It is known that a reflectivity of the cholesteric liquid crystalline phase depends on Δn, and in a case of obtaining the same degree of the reflectivity, as Δn increases, the number of helical pitches decreases, that is, a film thickness can be decreased.

As a measuring method of the sense or pitch of the helix, methods disclosed in “Introduction: Liquid Crystal Experiments” (edited by the Japanese Liquid Crystal Society, Sigma Publications, published in 2007 p. 46) and “Liquid Crystal Handbook” (Liquid Crystal Handbook Editorial Committee, Maruzen Publishing, p. 196) can be used.

The reflected light of the cholesteric liquid crystalline phase is circularly polarized light. The fact whether or not the reflected light is right circularly polarized light or left circularly polarized light depends on a twisted direction of the helix of the cholesteric liquid crystalline phase. Regarding the selective reflection of the circularly polarized light due to the cholesteric liquid crystalline phase, in a case where the twisted direction of the helix of the cholesteric liquid crystalline phase is right, the right circularly polarized light is reflected, and in a case where the twisted direction of the helix of the cholesteric liquid crystalline phase is left, the left circularly polarized light is reflected.

In the transmission decorative laminate 10a, the blue right circular polarization reflection region 14rB and the green right circular polarization reflection region 14rG are a layer formed by fixing a right-twisted cholesteric liquid crystalline phase.

A direction of revolution of the cholesteric liquid crystalline phase can be adjusted in accordance with the kinds of a liquid crystal compound forming the reflection region or the kinds of a chiral agent to be added.

A thickness of the cholesteric liquid crystalline layer 14a is not particularly limited, and is preferably 1 to 10 μm, more preferably 2 to 8 μm, and even more preferably 3 to 6 μm, from a viewpoint of both excellent color developability and alignment.

More specific configuration and manufacturing method of the cholesteric liquid crystalline layer will be described later.

The base material 12a is a transparent red base material which absorbs blue light and green light. That is, the base material 12a is a transparent base material which transmits red light.

FIG. 3 shows a transmission spectrum of the base material 12a. As shown in FIG. 3, the base material 12a absorbs light at the same wavelength as the selective reflection wavelength λa of the blue right circular polarization reflection region 14rB and light at the same wavelength as the selective reflection wavelength λb of the green right circular polarization reflection region 14rG.

With the configuration described above, the visual effect differs, in a case where the transmission decorative laminate 10a is observed from the cholesteric liquid crystalline layer 14a side and the base material 12a side, respectively.

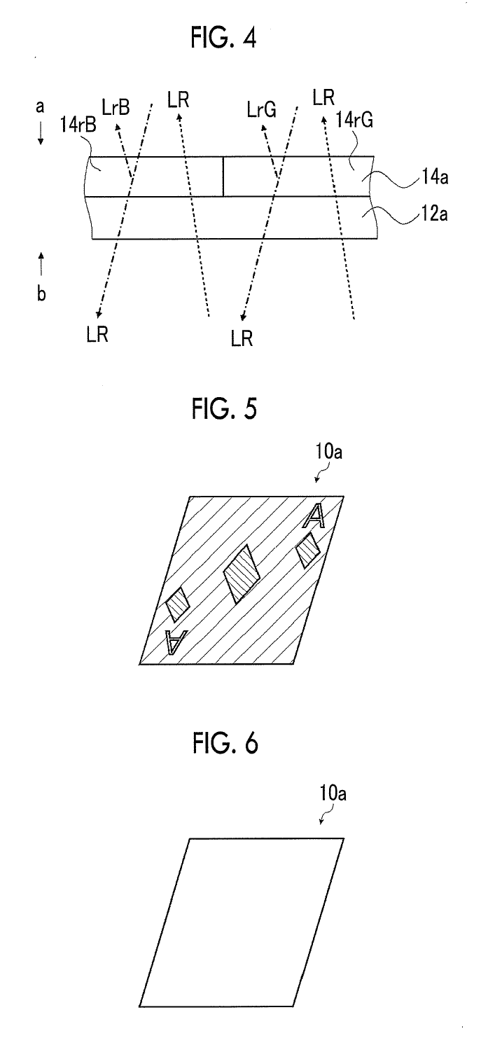

Next, the operation of the transmission decorative laminate 10a will be described with reference to FIG. 4. Hereinafter, the operation is described by setting a surface on the cholesteric liquid crystalline layer 14a side as a “front surface” and by setting a surface on the base material 12a side as a “rear surface”. The transmission decorative laminates of Second Embodiment and Three Embodiment which will be described later are also described by setting a surface on a cholesteric liquid crystalline layer side as a “front surface” and by setting a surface on a base material side as a “rear surface”.

As shown in FIG. 4, among light incident to the transmission decorative laminate 10a from the front surface side, right circularly polarized blue light LrB is reflected in the blue right circular polarization reflection region 14rB, and the light not reflected in the blue right circular polarization reflection region 14rB is transmitted through the blue right circular polarization reflection region 14rB and is incident to the base material 12a. Among the light incident to the base material 12a, blue light and green light are absorbed by the base material 12a and red light LR is transmitted through the base material 12a.

In addition, right circularly polarized green light LrG is reflected in the green right circular polarization reflection region 14rQG and the light not reflected in the green right circular polarization reflection region 14rG is transmitted through the green right circular polarization reflection region 14rG and is incident to the base material 12a. Among the light incident to the base material 12a, blue light and green light are absorbed by the base material 12a and red light LR is transmitted through the base material 12a.

Meanwhile, among the light incident to the transmission decorative laminate 10a from the rear surface side, only the red light LR is transmitted through the base material 12a. The red light LR transmitted through the base material 12a is incident to the blue right circular polarization reflection region 14rB and the green right circular polarization reflection region 14rG of the cholesteric liquid crystalline layer 14a, but the wavelength range of the red light LR and the selective reflection range of the blue right circular polarization reflection region 14rB and the green right circular polarization reflection region 14rG are not overlapped. Accordingly, the red light LR is not reflected by the cholesteric liquid crystalline layer 14a and transmitted through the cholesteric liquid crystalline layer 14a.

Accordingly, in a case where the transmission decorative laminate 10a is observed from the front surface side (in FIG. 4, in a view in the a direction), the scene of the other side of the transmission decorative laminate 10a is visually recognized by the red light LR transmitted and incident from the rear surface side, and light at the selective reflection wavelength of the reflection region of the cholesteric liquid crystalline layer 14a is visually recognized.

That is, in a view in the a direction in FIG. 4, an image having a pattern according to a formation pattern of the reflection region of the cholesteric liquid crystalline layer 14a is visually recognized (FIG. 5).

In addition, in a case where the transmission decorative laminate 10a is observed from the rear surface side (in FIG. 4, in a view in the b direction), the scene of the other side of the transmission decorative laminate 10a is visually recognized by the red light LR transmitted and incident from the front surface side. However, the reflected light derived from the cholesteric liquid crystalline layer 14a is not visually recognized, and accordingly, an image displayed on the cholesteric liquid crystalline layer 14a which can be observed from the front surface side is not visually recognized (FIG. 6).

Therefore, the transmission decorative laminate 10a have an image seen from one surface side (a direction) and an image seen from the other surface side (b direction), while having transparency.

### Second Embodiment

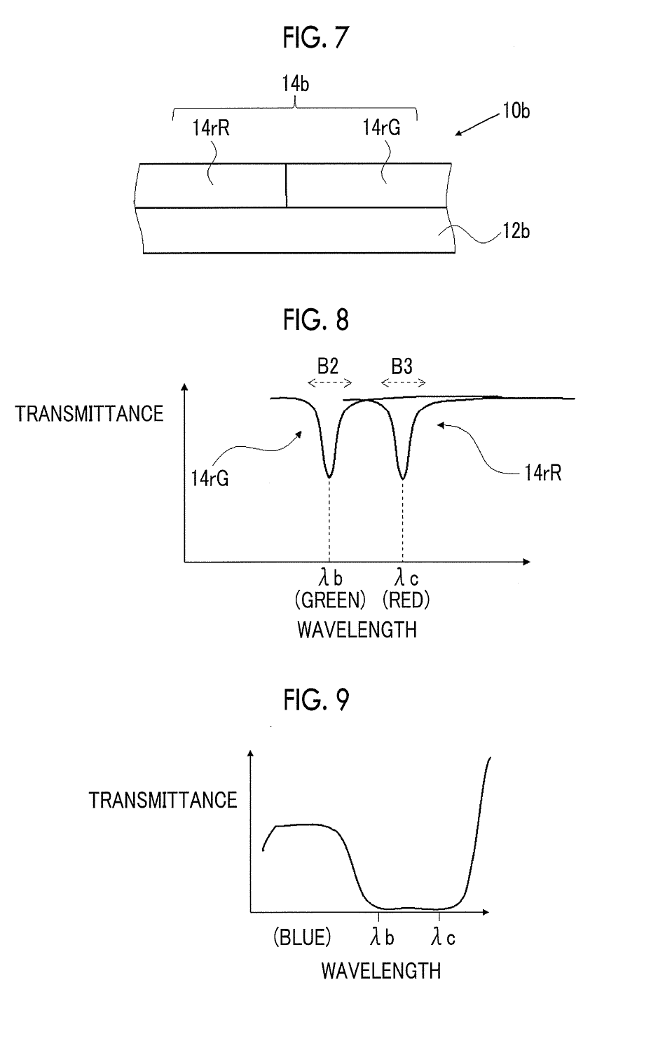

FIG. 7 shows a cross section schematic view showing another example of the embodiment (Second Embodiment) of the transmission decorative laminate of the present invention.

FIG. 7 is a cross section schematic view showing an example of the embodiment (Second Embodiment) of the transmission decorative laminate of the present invention. A transmission decorative laminate 10b includes a base material 12b and a cholesteric liquid crystalline layer 14b disposed on the base material 12b.

The cholesteric liquid crystalline layer 14b is a layer formed by fixing a cholesteric liquid crystalline phase and includes two regions having helical pitches of the cholesteric liquid crystalline phase different from each other. More specifically, the cholesteric liquid crystalline layer 14b includes a red right circular polarization reflection region 14rR which reflects right circularly polarized red light and transmits left circularly polarized red light and light in other wavelength ranges, and the green right circular polarization reflection region 14rG which reflects right circularly polarized green light and transmits left circularly polarized green light and light in other wavelength ranges. That is, in the cholesteric liquid crystalline layer 14b, the red right circular polarization reflection region 14rR and the green right circular polarization reflection region 14rG are formed in a desired pattern.

Each of the red right circular polarization reflection region 14rR and the green right circular polarization reflection region 14rG is formed by fixing a cholesteric liquid crystalline phase and has wavelength selective reflectivity with respect to right circularly polarized light in a specific wavelength range.

FIG. 8 shows transmission spectra of the red right circular polarization reflection region 14rR and the green right circular polarization reflection region 14rG. The red right circular polarization reflection region 14rR includes a selective reflection range B3 and the selective reflection wavelength thereof is shown as λc (nm). The selective reflection wavelength λc is positioned in a wavelength range of red light. The green right circular polarization reflection region 14rG includes the selective reflection range B2 and the selective reflection wavelength thereof is shown as λb (nm). The selective reflection wavelength 2b is positioned in a wavelength range of green light.

The base material 12b is a transparent blue base material which absorbs green light and red light. That is, the base material 12b is a transparent base material which transmits blue light.

FIG. 9 shows a transmission spectrum of the base material 12b. As shown in FIG. 9, the base material 12b absorbs light at the same wavelength as the selective reflection wavelength kb of the green right circular polarization reflection region 14rG and light at the same wavelength as the selective reflection wavelength λc of the red right circular polarization reflection region 14rR.

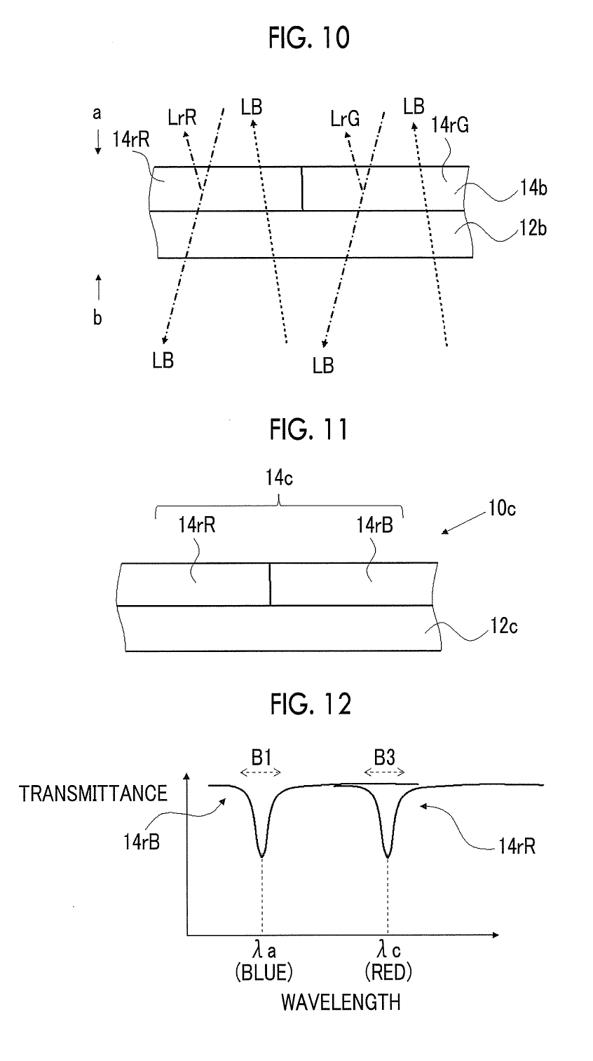

Next, the operation of the transmission decorative laminate 10b will be described with reference to FIG. 10.

As shown in FIG. 10, among light incident to the transmission decorative laminate 10b from the front surface side, right circularly polarized red light LrR is reflected in the red right circular polarization reflection region 14rR, and the light not reflected in the red right circular polarization reflection region 14rR is transmitted through the red right circular polarization reflection region 14rR and is incident to the base material 12b. Among the light incident to the base material 12b, green light and red light are absorbed by the base material 12b and blue light LB is transmitted through the base material 12b.

In addition, the right circularly polarized green light LrG is reflected in the green right circular polarization reflection region 14rG, and the light not reflected in the green right circular polarization reflection region 14rG is transmitted through the green right circular polarization reflection region 14rG and is incident to the base material 12b. Among the light incident to the base material 12b, green light and red light are absorbed by the base material 12b and blue light LB is transmitted through the base material 12b.

Meanwhile, among the light incident to the transmission decorative laminate 10b from the rear surface side, only the blue light LB is transmitted through the base material 12b. The blue light LB transmitted through the base material 12b is incident to the red right circular polarization reflection region 14rR and the green right circular polarization reflection region 14rG of the cholesteric liquid crystalline layer 14b, but the wavelength range of the blue light LB and the selective reflection range of the red right circular polarization reflection region 14rR and the green right circular polarization reflection region 14rG are not overlapped. Accordingly, the blue light LB is not reflected by the cholesteric liquid crystalline layer 14b and transmitted through the cholesteric liquid crystalline layer 14b.

Accordingly, in a case where the transmission decorative laminate 10b is observed from the front surface side (in FIG. 10, in a view in the a direction), the scene of the other side of the transmission decorative laminate 10b is visually recognized by the blue light LB transmitted and incident from the rear surface side, and light at the selective reflection wavelength of the reflection region of the cholesteric liquid crystalline layer 14b is visually recognized.

That is, in a view in the a direction in FIG. 10, an image having a pattern according to a formation pattern of the reflection region of the cholesteric liquid crystalline layer 14b is visually recognized.

In addition, in a case where the transmission decorative laminate 10b is observed from the rear surface side (in FIG. 10, in a view in the b direction), the scene of the other side of the transmission decorative laminate 10b is visually recognized by the blue light LB transmitted and incident from the front surface side. However, the reflected light derived from the cholesteric liquid crystalline layer 14b is not visually recognized, and accordingly, an image displayed on the cholesteric liquid crystalline layer 14b which can be observed from the front surface side is not visually recognized.

Therefore, the transmission decorative laminate 10b have an image seen from one surface side (a direction) and an image seen from the other surface side (b direction), while having transparency.

### Third Embodiment

FIG. 11 shows a cross section schematic view showing another example of the embodiment (Third Embodiment) of the transmission decorative laminate of the present invention.

FIG. 11 is a cross section schematic view showing an example of the embodiment (Third Embodiment) of the transmission decorative laminate of the present invention. A transmission decorative laminate 10c includes a base material 12c and a cholesteric liquid crystalline layer 14c disposed on the base material 12c.

The cholesteric liquid crystalline layer 14c is a layer formed by fixing a cholesteric liquid crystalline phase and includes two regions having helical pitches of the cholesteric liquid crystalline phase different from each other. More specifically, the cholesteric liquid crystalline layer 14c includes the red right circular polarization reflection region 14rR which reflects right circularly polarized red light and transmits left circularly polarized red light and light in other wavelength ranges, and the blue right circular polarization reflection region 14rB which reflects right circularly polarized blue light and transmits left circularly polarized blue light and light in other wavelength ranges. That is, in the cholesteric liquid crystalline layer 14c, the red right circular polarization reflection region 14rR and the blue right circular polarization reflection region 14rB are formed in a desired pattern.

Each of the red right circular polarization reflection region 14rR and the blue right circular polarization reflection region 14rB is formed by fixing a cholesteric liquid crystalline phase and has wavelength selective reflectivity with respect to right circularly polarized light in a specific wavelength range.

FIG. 12 shows transmission spectra of the red right circular polarization reflection region 14rR and the blue right circular polarization reflection region 14rB. The red right circular polarization reflection region 14rR includes the selective reflection range B3 and the selective reflection wavelength thereof is shown as λc (nm). The selective reflection wavelength λc is positioned in a wavelength range of red light. The blue right circular polarization reflection region 14rB includes the selective reflection range B1 and the selective reflection wavelength thereof is shown as λa (nm). The selective reflection wavelength λa is positioned in a wavelength range of blue light.

The base material 12c is a transparent green base material which absorbs blue light and red light. That is, the base material 12c is a transparent base material which transmits green light.

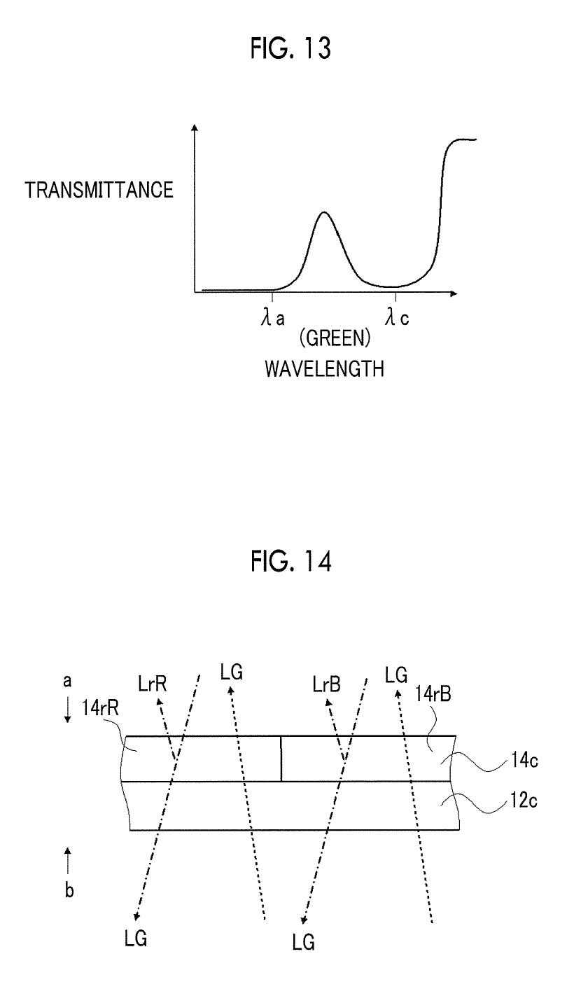

FIG. 13 shows a transmission spectrum of the base material 12c. As shown in FIG. 13, the base material 12c absorbs light at the same wavelength as the selective reflection wavelength λa of the blue right circular polarization reflection region 14rB and light at the same wavelength as the selective reflection wavelength λc of the red right circular polarization reflection region 14rR.

Next, the operation of the transmission decorative laminate 10c will be described with reference to FIG. 14.

As shown in FIG. 14, among light incident to the transmission decorative laminate 10c from the front surface side, right circularly polarized red light LrR is reflected in the red right circular polarization reflection region 14rR, and the light not reflected in the red right circular polarization reflection region 14rR is transmitted through the red right circular polarization reflection region 14rR and is incident to the base material 12c. Among the light incident to the base material 12c, blue light and red light are absorbed by the base material 12c and green light LG is transmitted through the base material 12c.

In addition, the right circularly polarized blue light LrB is reflected in the blue right circular polarization reflection region 14rB, and the light not reflected in the blue right circular polarization reflection region 14rB is transmitted through the blue right circular polarization reflection region 14rB and is incident to the base material 12c. Among the light incident to the base material 12c, blue light and red light are absorbed by the base material 12c and green light LG is transmitted through the base material 12c.

Meanwhile, among the light incident to the transmission decorative laminate 10c from the rear surface side, only the green light LG is transmitted through the base material 12c. The green light LG transmitted through the base material 12c is incident to the red right circular polarization reflection region 14rR and the blue right circular polarization reflection region 14rB of the cholesteric liquid crystalline layer 14c, but the wavelength range of the green light LG and the selective reflection range of the red right circular polarization reflection region 14rR and the blue right circular polarization reflection region 14rB are not overlapped. Accordingly, the green light LG is not reflected by the cholesteric liquid crystalline layer 14c and transmitted through the cholesteric liquid crystalline layer 14c.

Accordingly, in a case where the transmission decorative laminate 10c is observed from the front surface side (in FIG. 14, in a view in the a direction), the scene of the other side of the transmission decorative laminate 10c is visually recognized by the green light LG transmitted and incident from the rear surface side, and light at the selective reflection wavelength of the reflection region of the cholesteric liquid crystalline layer 14c is visually recognized.

That is, in a view in the a direction in FIG. 14, an image having a pattern according to a formation pattern of the reflection region of the cholesteric liquid crystalline layer 14c is visually recognized.

In addition, in a case where the transmission decorative laminate 10c is observed from the rear surface side (in FIG. 14, in a view in the b direction), the scene of the other side of the transmission decorative laminate 10c is visually recognized by the green light LG transmitted and incident from the front surface side. However, the reflected light derived from the cholesteric liquid crystalline layer 14c is not visually recognized, and accordingly, an image displayed on the cholesteric liquid crystalline layer 14c which can be observed from the front surface side is not visually recognized.

Therefore, the transmission decorative laminate 10c have an image seen from one surface side (a direction) and an image seen from the other surface side (b direction), while having transparency.

In First Embodiment to Third Embodiment, the cholesteric liquid crystalline layer reflecting right circularly polarized light has been described, but the present invention is not limited thereto, and a cholesteric liquid crystalline layer reflecting left circularly polarized light may be used.

In the above description, the cholesteric liquid crystalline layer including the blue right circular polarization reflection region 14rB and the green right circular polarization reflection region 14rG has been described in First Embodiment, the cholesteric liquid crystalline layer including the red right circular polarization reflection region 14rR and the green right circular polarization reflection region 14rG has been described in Second Embodiment, and the cholesteric liquid crystalline layer including the red right circular polarization reflection region 14rR and the blue right circular polarization reflection region 14rB has been described in Third Embodiment, but the present invention is not limited to this combination, as long as it is a cholesteric liquid crystalline layer including two or more reflection regions having different selective reflection wavelengths.

A difference between selective reflection wavelengths of two or more reflection regions is not particularly limited, and the selective reflection wavelengths of two or more reflection regions are preferably different from each other by 30 nm or more and more preferably different from each other by 45 nm or more.

In First Embodiment to Third Embodiment, the cholesteric liquid crystalline layer has a configuration including two kinds of the reflection regions having different selective reflection wavelengths, but the present invention is not limited thereto, as long as it is a configuration including three or more kinds of reflection regions.

The selective reflection wavelength in the reflection region can be set in any range of visible light (approximately 380 to 780 nm), near infrared light (approximately higher than 780 nm and equal to or lower than 2,000 nm), and ultraviolet light (approximately 315 to 380 nm) and the setting method thereof is as described above.

The transparent red base material has been described in First Embodiment, the transparent blue base material has been described in Second Embodiment, and the transparent green base material has been described in Third Embodiment, but the present invention is not limited thereto, as long as it is a colored transparent base material.

In the present invention, the base material may be transparent. The transparent base material may have properties of transmitting light in any region of visible light region. More specifically, the base material preferably includes a region having a transmittance exceeding 30%, more preferably includes a region having a transmittance of 50% or more, and even more preferably includes a region having a transmittance of 70% or more, in a wavelength range of 380 to 780 nm.

In the embodiment, the base material may be colored. The colored base material may have properties of absorbing light in any region of the visible light region. A width of an absorption band of the colored transparent base material is not particularly limited and is 30 to 300 nm, in many cases.

In the colored transparent base material, all of transmittances at the selective reflection wavelengths in the two or more reflection regions are preferably 30% or less and more preferably 20% or less. A lower limit thereof is not particularly limited, and may be 0%.

As an example of the aspect, in a case of the base material 12a of First Embodiment described above, for example, each transmittance at the wavelength % a and the wavelength 2b of the base material 12a is preferably 30% or less.

In a case where each of the transmittance of the wavelength λa and the wavelength λb of the base material 12a is 30% or less and the transmission decorative laminate 10a is observed from the rear surface side, an image derived from the cholesteric liquid crystalline layer 14a is more hardly visually recognized.

Accordingly, in the colored transparent base material, it is desirable that, not only the transmittance at the same wavelength as each selective reflection wavelength derived from two or more reflection region, but also the transmittance is in the range described above (30% or less) at any wavelength in the selective reflection range of each reflection region.

In First Embodiment to Third Embodiment, the transmission decorative laminate in which the cholesteric liquid crystalline layer is formed of only one layer has been described, but there is no limitation to this aspect, and for example, a plurality of the cholesteric liquid crystalline layers may be laminated. In a case where the plurality of the cholesteric liquid crystalline layers are laminated, a helical revolution direction may be set to be the same direction or the opposite direction for each layer. In a case where the plurality of the cholesteric liquid crystalline layers are laminated, each selective reflection wavelength of the reflection region of each layer may be different from each other.

Hereinafter, each member configuring the transmission decorative laminate will be described.

<Colored Transparent Base Material>

The material configuring the colored transparent base material is not particularly limited, and examples thereof include glass and plastic, and the plastic is preferable.

Examples of plastic include a cellulose-based polymer, a polycarbonate-based polymer, a polyester-based polymer, a (meth)acrylic polymer, a styrene-based polymer, a polyolefin-based polymer, a vinyl chloride-based polymer, an amide-based polymer, an imide-based polymer, a sulfone-based polymer, a polyether sulfone-based polymer, and a polyether ether ketone-based polymer, and among these, polyethylene terephthalate (PET), a (meth)acrylic polymer, or cellophane is preferable.

The base material is a colored transparent base material which is colored in red (R), green (G), blue (B), and the like as described above. A method of coloring the base material is not particularly limited, and examples thereof include a method of applying a dye or a pigment and a method of providing a colored transparent layer on a surface of a transparent base material. From viewpoints of widening a selection width of the selective reflection wavelength of the cholesteric liquid crystalline layer (that is, forming a more colorful image by increasing the number of options of color tones of the cholesteric liquid crystalline layer) and maintaining the transmittance of the base material, the base material is preferably a colored transparent base material which is colored in red (R), green (G), or blue (B). For example, in a case where the color of the colored transparent base material is yellow (Y), the transmittance thereof is excellent, due to a high transmittance at a wavelength of 450 to 800 nm, however, a wavelength range for sufficiently absorbing light is relatively narrow (wavelength range of 380 and less than 450 nm), and accordingly, a selection with of the selective reflection wavelength which can be used in the cholesteric liquid crystalline layer is narrow.

A colored transparent base material which is colored in blue (B) preferably has a transmission center wavelength, specifically, at 420 to 490 nm, a colored transparent base material which is colored in green (G) preferably has a transmission center wavelength, specifically, at higher than 500 to 570 nm, and a colored transparent base material which is colored in red (R) preferably has a transmission center wavelength, specifically, at higher than 600 to 750 nm.

The base material may include various additives (for example, an ultraviolet (UV) absorbing agent, matting agent fine particles, a plasticizer, a deterioration inhibiting agent, and a release agent).

The base material preferably has low birefringence in the visible light region. For example, a phase difference (in-plane retardation) of the base material at a wavelength of 550 nm is preferably equal to or smaller than 50 nm and more preferably equal to or smaller than 20 nm.

The base material may include a curved surface. In addition, the base material may have a recessed or protruded shape.

A thickness of the base material is not particularly limited, and is preferably 10 to 2,000 μm and more preferably 15 to 1,500 μm, from viewpoints of thinning and handling properties.

The thickness means an average thickness and is an arithmetical mean of values obtained by measuring thicknesses of five random points of the base material.

The transmittance of the base material can be measured by a spectrophotometer.

<Cholesteric Liquid Crystalline Layer>

The cholesteric liquid crystalline layer is a layer formed by fixing a cholesteric liquid crystalline phase.

The structure in which the cholesteric liquid crystalline phase is fixed may be a structure in which the alignment of the liquid crystal compound becoming the cholesteric liquid crystalline phase is maintained, and may be a structure in which, typically, a polymerizable liquid crystal compound is set in an alignment state of a cholesteric liquid crystalline phase, polymerized and cured by ultraviolet light irradiation or heating, to form a layer not having fluidity, and at the same time, the alignment aspect is changed to a state which does not change due to the external field or the external force. In the structure in which the cholesteric liquid crystalline phase is fixed, it is enough, as long as the optical properties of the cholesteric liquid crystalline phase are maintained, and the liquid crystal compound may not have liquid crystal properties. For example, the polymerizable liquid crystal compound may lose liquid crystal properties due to an increase in molecular weight due to a curing reaction.

As the material used in the formation of the cholesteric liquid crystalline layer, a liquid crystal composition including a liquid crystal compound or the like is used. The liquid crystal compound is preferably a liquid crystal compound having a polymerizable group (polymerizable liquid crystal compound).

The liquid crystal composition including a polymerizable liquid crystal compound may further include a surfactant, a chiral agent, or a polymerization initiator. Hereinafter, each component will be described.

—Polymerizable Liquid Crystal Compound—

The polymerizable liquid crystal compound may be a rod-like liquid crystal compound or a disk-like liquid crystal compound, and a rod-like liquid crystal compound is preferably used.

As an example of a rod-like polymerizable liquid crystal compound for forming the cholesteric liquid crystalline layer, a rod-like nematic liquid crystal compound may be used. As a rod-like nematic liquid crystal compound, azomethines, azoxys, cyano biphenyls, cyanophenyl esters, benzoic acid esters, cyclohexane carboxylic acid phenyl esters, cyanophenyl cyclohexanes, cyano-substituted phenyl pyrimidines, alkoxy-substituted phenyl pyrimidines, phenyl dioxanes, tolanes, or alkenylcyclohexylbenzonitriles are preferably used. Not only a low-molecular-weight liquid crystal compound, but also a high-molecular-weight liquid crystal compound can be used.

A polymerizable liquid crystal compound is obtained by introducing a polymerizable group to the liquid crystal compound. Examples of the polymerizable group include an unsaturated polymerizable group, an epoxy group, and an aziridinyl group, an unsaturated polymerizable group is preferable and an ethylenically unsaturated polymerizable group is more preferable. The polymerizable group can be introduced into molecules of the liquid crystal compound by various methods. The number of polymerizable groups included in the polymerizable liquid crystal compound is preferably 1 to 6 and more preferably 1 to 3.

Examples of the polymerizable liquid crystal compound include compounds disclosed in Makromol. Chem., vol. 190, 2255 p, (1989), Advanced Materials, vol. 5, 107 p (1993), U.S. Pat. Nos. 4,683,327A, 5,622,648A, 5,770,107A, WO95/022586A, WO95/024455A, WO97/000600A, WO98/023580A, WO098/052905A, JP1989-272551A (JP-H01-272551A), JP1994-016616A (JP-H06-016616A), JP1995-110469A (JP-H07-110469A), JP1999-080081A (JP-H11-080081A), and JP2001-328973A. Two or more kinds of polymerizable liquid crystal compounds may be used in combination. In a case where two or more kinds of polymerizable liquid crystal compounds are used in combination, it is possible to decrease an alignment temperature.

Specific examples of the polymerizable liquid crystal compound include compounds shown in Formulae (1) to (11).

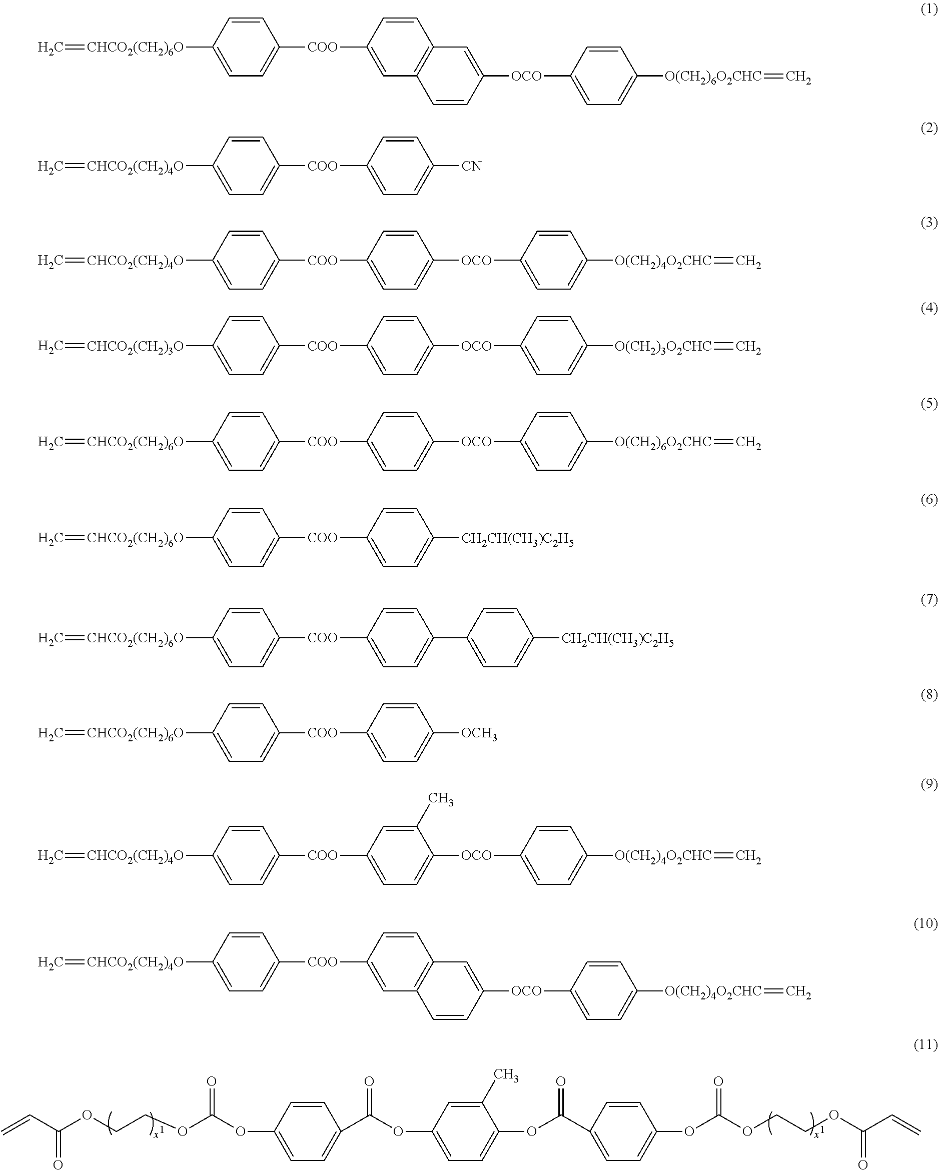

[In the compound (11), X¹ is 2 to 5 (integer).]

In addition, as the polymerizable liquid crystal compound other than the polymerizable liquid crystal compound described above, a cyclic organopolysiloxane compound including a cholesteric phase disclosed in JP1982-165480A (JP-S57-165480A) can be used. Further, as the high-molecular-weight liquid crystal compound described above, a polymer obtained by introducing a mesogenic group having liquid crystal to a main chain, a side chain, or both positions of the main chain and the side chain, a high-molecular-weight cholesteric liquid crystal obtained by introducing a cholesteric group to a side chain, a liquid crystal polymer disclosed in JP1997-133810A (JP-H09-133810A), and a liquid crystal polymer disclosed in JP1999-293252A (JP-H11-293252A) can be used.

From viewpoints of fast curability, film hardness improvement, polarization ratio improvement, and durability improvement, the content of the liquid crystal compound including two or more polymerizable groups in the liquid crystal compound is preferably equal to or greater than 60% by mass, more preferably equal to or greater than 70% by mass, and even more preferably equal to or greater than 80% by mass, with respect to a total mass of the liquid crystal compound.

In addition, the added amount of the polymerizable liquid crystal compound in the liquid crystal composition is preferably 75% to 99.9% by mass, more preferably 80% to 99% by mass, and even more preferably 85% to 90% by mass, with respect to the solid content mass (mass excluding the solvent) of the liquid crystal composition.

—Chiral Agent (Optically Active Compound)—

The chiral agent has a function of inducing the helical structure of the cholesteric liquid crystalline phase. Since the induced twisted direction of the helix or the helical pitch varies according to the compound, the chiral compound may be selected according to the purpose.

The chiral agent is not particularly limited, and well-known compounds (for example, Liquid Crystal Device Handbook, third vol. paragraphs 4-3, a chiral agent for twisted nematic (TN) or super-twisted nematic (STN), p. 199, Japan Society for the Promotion of Science 142th Committee Edition, 1989), isosorbide, or an isomannide derivative can be used.

The chiral agent generally includes asymmetric carbon atoms, but an axial asymmetric compound or a planar asymmetric compound not including asymmetric carbon atoms can be used as the chiral agent. As an example of an axial asymmetric compound or a planar asymmetric compound, binaphthyl, helicene, paracyclophane, and derivatives thereof are included. The chiral agent may include a polymerizable group. In a case where both of the chiral agent and the liquid crystal compound include a polymerizable group, it is possible to form a polymer including a repeating unit derived from the polymerizable liquid crystal compound and a repeating unit derived from the chiral agent, by the polymerization reaction between the polymerizable chiral agent and the polymerizable liquid crystal compound. In this aspect, the polymerizable group included in the polymerizable chiral agent is preferably the same kind of group as the polymerizable group included in the polymerizable liquid crystal compound. Accordingly, the polymerizable group of the chiral agent is preferably an unsaturated polymerizable group, an epoxy group, or an aziridinyl group, more preferably an unsaturated polymerizable group, and particularly preferably an ethylenically unsaturated polymerizable group.

In addition, the chiral agent may be a liquid crystal compound.

As will be described later, in a case of controlling a size of the helical pitch of the cholesteric liquid crystalline phase in accordance with the exposed amount, in a case of manufacturing the cholesteric liquid crystalline layer, a chiral agent sensitive to light and capable of changing the helical pitch of the cholesteric liquid crystalline phase (hereinafter, also referred to as a photosensitive chiral agent) is preferably used.

The photosensitive chiral agent is a compound, the structure of which is changed by absorbing light, and which changes the helical pitch of the cholesteric liquid crystalline phase. As such a compound, a compound which causes at least one of a photoisomerization reaction, a photo dimerization reaction, or a photodegradation reaction is preferable.

The compound causing the photoisomerization reaction is a compound causing stereoisomerization or structure isomerization reaction by the operation of light. Examples of the photoisomerization compound include an azobenzene compound, and a spiropyran compound.

In addition, the compound causing the photo dimerization reaction is a compound which cyclizes by causing an addition reaction between two groups due to the light irradiation. Examples of the photo dimerization compound include a cinnamic acid derivative, a coumarin derivative, a chalcone derivative, and a benzophenone derivative.

As the photosensitive chiral agent, a chiral agent represented by General Formula (I) is preferably used. This chiral agent may change an alignment structure of the helical pitch (twisting force or angle of twist of helix) of the cholesteric liquid crystalline phase in accordance with light intensity during the light irradiation.

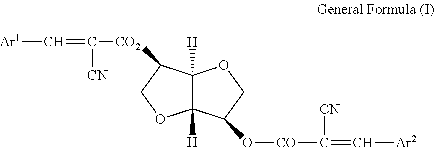

In General Formula (I), Ar¹ and Ar² represent an aryl group or a heteroaromatic ring group.

The aryl group represented by Ar¹ and Ar² may include a substituent, a total number of carbon atoms is preferably 6 to 40 and more preferably 6 to 30. As the substituent, for example, a halogen atom, an alkyl group, an alkenyl group, an alkynyl group, an alkoxy group, a hydroxyl group, an acyl group, an alkoxycarbonyl group, an aryloxycarbonyl group, an acyloxy group, a carboxyl group, a cyano group, or a heterocyclic group is preferable, and a halogen atom, an alkyl group, an alkenyl group, an alkoxy group, a hydroxyl group, an acyloxy group, an alkoxycarbonyl group or an aryloxycarbonyl group is more preferable.

Among such aryl groups, an aryl group represented by General Formula (III) or (IV) is preferable.

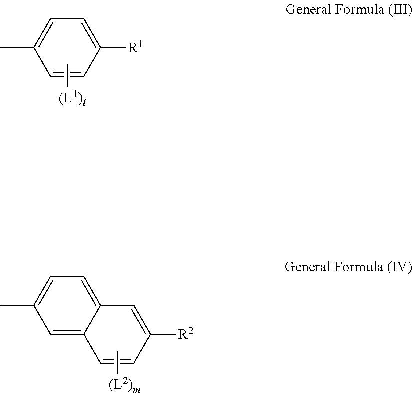

R¹ in General Formula (III) and R² in General Formula (IV) each independently represent a hydrogen atom, a halogen atom, an alkyl group, an alkenyl group, an alkynyl group, an aryl group, a heterocyclic group, an alkoxy group, a hydroxyl group, an acyl group, an alkoxycarbonyl group, an aryloxycarbonyl group, an acyloxy group, a carboxyl group, or a cyano group. Among these, a hydrogen atom, a halogen atom, an alkyl group, an alkenyl group, an aryl group, an alkoxy group, a hydroxyl group, an alkoxycarbonyl group, an aryloxycarbonyl group, or an acyloxy group is preferable, and an alkoxy group, a hydroxyl group, or an acyloxy group is more preferable.

L¹ in General Formula (III) and L² in General Formula (IV) each independently represent a halogen atom, an alkyl group, an alkoxy group, or a hydroxyl group, and an alkoxy group having 1 to 10 carbon atoms or a hydroxyl group is preferable.

1 represents an integer of 0, 1 to 4 and 0 or 1 is preferable. m represents an integer of 0, 1 to 6 and 0 or 1 is preferable. In a case where 1 or m is equal to or greater than 2, L¹ and L² may represent groups different from each other.

A heteroaromatic ring group represented by Ar¹ and Ar² may include a substituent, and a total number of carbon atoms is preferably 4 to 40 and more preferably 4 to 30. As the substituent, for example, a halogen atom, an alkyl group, an alkenyl group, an alkynyl group, an aryl group, an alkoxy group, a hydroxyl group, an acyl group, an alkoxycarbonyl group, an aryloxycarbonyl group, an acyloxy group, or a cyano group is preferable, and a halogen atom, an alkyl group, an alkenyl group, an aryl group, an alkoxy group, or an acyloxy group is more preferable.

Examples of the heteroaromatic ring group include a pyridyl group, a pyrimidinyl group, a furyl group, and a benzofuranyl group, and among these, a pyridyl group or a pyrimidinyl group is preferable.

A content of the chiral agent in the liquid crystal composition is preferably 0.01 to 200 mol % and more preferably 1 to 30 mol % with respect to the content of the polymerizable liquid crystal compound.

—Polymerization Initiator—

In a case where the liquid crystal composition includes the polymerizable compound, the liquid crystal composition preferably includes a polymerization initiator. In an aspect of causing the polymerization reaction to proceed using the ultraviolet light irradiation, the polymerization initiator used is preferably a photopolymerization initiator which can start the polymerization reaction by an ultraviolet light irradiation. Examples of the photopolymerization initiator include an α-carbonyl compound (disclosed in each specification of U.S. Pat. Nos. 2,367,661A and 2,367,670A), acyloin ether (disclosed in the specification of U.S. Pat. No. 2,448,828A), an α-hydrocarbon-substituted aromatic acyloin compound (disclosed in the specification of U.S. Pat. No. 2,722,512A), a polynuclear quinone compound (disclosed in each specification of U.S. Pat. Nos. 3,046,127A and 2,951,758A), a combination of a triaryl imidazole dimer and p-amino phenyl ketone (disclosed in the specification of U.S. Pat. No. 3,549,367A), acridine and phenazine compounds (disclosed in each specification of JP1985-105667A (JP-S60-105667A) and U.S. Pat. No. 4,239,850A), and an oxadiazole compound (disclosed in the specification of U.S. Pat. No. 4,212,970A).

A content of the photopolymerization initiator in the liquid crystal composition is preferably 0.1% to 20% by mass and more preferably 0.5% by mass to 12% by mass, with respect to the content of the polymerizable liquid crystal compound.

—Cross-Linking Agent—

The liquid crystal composition may randomly include a cross-linking agent, in order to improve film hardness after the curing and durability. As the cross-linking agent, a material which is cured by ultraviolet light, heat, or humidity can be suitably used.

The cross-linking agent is not particularly limited and can be suitably selected according to the purpose, and examples thereof include a polyfunctional acrylate compound such as trimethylolpropane tri(meth)acrylate or pentaerythritol tri(meth)acrylate; an epoxy compound such as glycidyl (meth)acrylate or ethylene glycol diglycidyl ether; an aziridine compound such as 2,2-bishydroxymethylbutanol-tris[3-(1-aziridinyl)propionate] or 4,4-bis (ethylene iminocarbonyl amino)diphenylmethane; an isocyanate compound such as hexamethylene diisocyanate or biuret type isocyanate; a polyoxazoline compound including an oxazoline group as a side chain; and an alkoxysilane compound such as vinyltrimethoxysilane or N-(2-aminoethyl)3-aminopropyltrimethoxysilane. In addition, a well-known catalyst can be used according to the reactivity of the cross-linking agent and it is possible to improve productivity, in addition to the improvement of film hardness and durability. These may be used alone or in combination of two or more kinds thereof.

A content of the cross-linking agent is preferably 3% by mass to 20% by mass and more preferably 5% by mass to 15% by mass with respect to a solid content mass of the liquid crystal composition.

—Other Additives—

If necessary, the liquid crystal composition may include a surfactant, a polymerization inhibitor, an antioxidant, a horizontal alignment agent, an ultraviolet absorbing agent, a light stabilizer, a coloring material, and metal oxide fine particles can be added to the liquid crystal composition, in a range not decreasing the optical performance.

The liquid crystal composition may include a solvent. The solvent is not particularly limited and can be suitably selected according to the purpose, and an organic solvent is preferable.

The organic solvent is not particularly limited and can be suitably selected according to the purpose, and examples thereof include ketones such as methyl ethyl ketone, methyl isobutyl ketone alkyl halides, amides, sulfoxides, heterocyclic compounds, hydrocarbons, esters, and ethers. These may be used alone or in combination of two or more kinds thereof.

<Method of Manufacturing Transmission Decorative Laminate>

The method of manufacturing the transmission decorative laminate is not particularly limited, and a well-known method can be used.

For example, a method of forming a cholesteric liquid crystalline layer on a colored transparent base material is used.

As the method of forming the cholesteric liquid crystalline layer, a manufacturing method including the following step 1 to step 4 is preferable, from a viewpoint of ease of control of the helical pitch of the cholesteric liquid crystalline phase.

Step 1: step of forming a coating by using a liquid crystal composition including a liquid crystal compound including a polymerizable group and a chiral agent sensitive to light and capable of changing a helical pitch of a cholesteric liquid crystalline phase

Step 2: step of performing an exposure treatment on the coating in a pattern shape, with light to which the chiral agent is sensitive

Step 3: step of performing a heating treatment on the coating subjected to the exposure treatment and aligning the liquid crystal compound to be in a state of a cholesteric liquid crystalline phase

Step 4: step of performing a curing treatment on the coating subjected to the heating treatment and forming the cholesteric liquid crystalline layer formed by fixing the cholesteric liquid crystalline phase

Hereinafter, the procedure of each step will be described with reference to the drawings.

(Step 1)

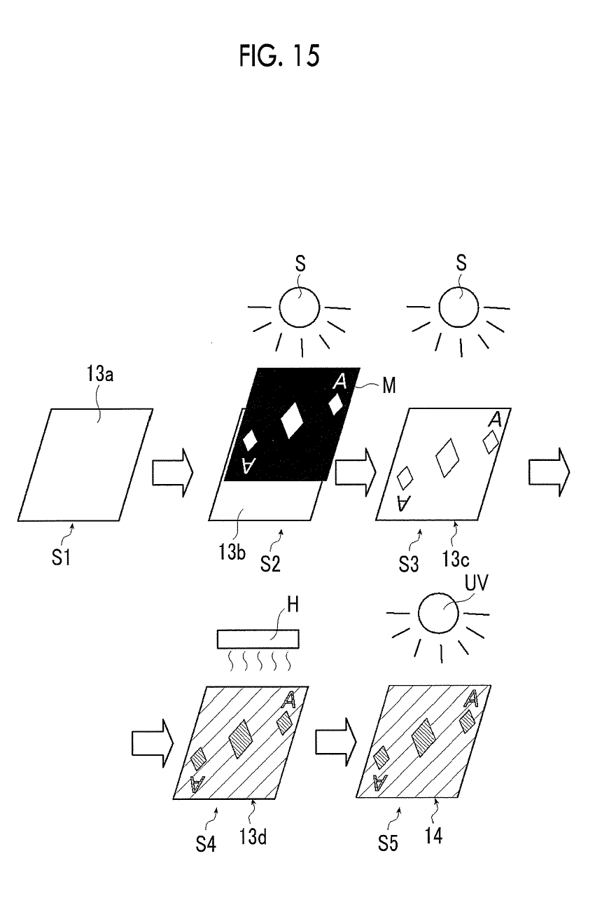

The step 1 is a step of forming a coating using a liquid crystal composition including a liquid crystal compound including a polymerizable group, and a chiral agent sensitive to light and capable of changing a helical pitch of a cholesteric liquid crystalline phase. As shown in S1 of FIG. 15, first, a coating 13a is formed by performing this step.

From a viewpoint of setting a cholesteric liquid crystalline layer having more excellent alignment properties and high transmittance, the alignment treatment may be performed with respect to a surface of a base material on which the coating is to be formed, before forming the coating. By performing the alignment treatment, it is possible to improve alignment properties of the cholesteric liquid crystalline phase formed on the coating and further increase transmittance of the transmission decorative laminate. As the base material, a colored transparent base material is used.

The liquid crystal compound including the polymerizable group included in the liquid crystal composition and the photosensitive chiral agent are as described above. The component which may be included in the liquid crystal composition is also as described above.

A concentration of solid contents of the liquid crystal composition is preferably 10% to 50% by mass and more preferably 20% to 40% by mass with respect to a total mass of the liquid crystal composition, from a viewpoint of coating properties.

As a method of forming the coating in the step 1, a method of applying the liquid crystal composition onto the base material is used. The coating method is not particularly limited, and examples thereof include a wire bar coating method, an extrusion coating method, a direct gravure coating method, a reverse gravure coating method, and a die-coating method. In addition, the coating may be formed by spraying.

If necessary, a process of drying the liquid crystal composition applied onto the base material may be performed after the applying. By performing the drying process, the solvent can be removed from the applied liquid crystal composition.

A film thickness of the coating is not particularly limited, and is preferably 0.1 to 20 μm, more preferably 0.2 to 15 μm, even more preferably 0.5 to 10 μm, from a viewpoint of more excellent reflectivity of the cholesteric liquid crystalline layer.

(Step 2)

The step 2 is a step of performing an exposure treatment with respect to the coating in a pattern shape, with light to which the chiral agent is sensitive. By performing this step, a difference can be provided between a helical induction force of the chiral agent in an exposure region and a helical induction force of the chiral agent in a non-exposure region. Accordingly, by further performing the procedure which will be described later, the reflection regions having different selective reflection wavelengths can be formed.

A method of performing the exposure treatment in a pattern shape is not particularly limited, and a method using a mask having an opening is used. More specifically, as shown in S2 of FIG. 15, the exposure is performed with respect to the coating 13a with light at a wavelength which is emitted by a light source S and to which the photosensitive chiral agent is sensitive, through a mask M having a predetermined opening pattern, and a partially exposed coating 13b is formed.

The wavelength of light emitted in this step is not particularly limited, as long as it is light at a wavelength to which the photosensitive chiral agent is sensitive.

In a case where the polymerization initiator is included in the liquid crystal composition, it is preferable to perform the exposure with light at a wavelength to which the polymerization initiator is hardly sensitive.

In a case of the light irradiation, the coating may be heated. A heating temperature is preferably 15° C. to 50° C. and more preferably 20° C. to 40° C.

After performing the step 2, if necessary, as shown in S3 of FIG. 15, the entire surface of the coating may be irradiated with the light at a wavelength to which the photosensitive chiral agent is sensitive to obtain the entirely exposed coating 13c. By performing this step, a helical induction force can be adjusted so as to obtain a predetermined helical pitch, by sensing the chiral agent in the non-exposure region in the step 2.

(Step 3)

The step 3 is a step of performing a heating treatment with respect to the coating subjected to the exposure treatment in the step 2 and aligning the liquid crystal compound to be in a state of a cholesteric liquid crystalline phase. By performing this step, as shown in S4 of FIG. 15, a coating 13d in a state of the cholesteric liquid crystalline phase can be formed by the heating treatment using a heater H or the like.

A liquid crystal phase transfer temperature of the liquid crystal composition is preferably 10° C. to 250° C. and more preferably 10° C. to 150° C., from a viewpoint of manufacturing suitability.

As the preferable heating conditions, the coated layer is preferably heated at 40° C. to 100° C. (preferably 60° C. to 100° C.) for 0.5 to 5 minutes (preferably 0.5 to 2 minutes).

(Step 4)

The step 4 is a step of performing a curing treatment with respect to the coating subjected to the heating treatment and forming the cholesteric liquid crystalline layer formed by fixing the cholesteric liquid crystalline phase.

The method of curing treatment is not particularly limited, and a photocuring treatment and a heat curing treatment are used. Among these, the light irradiation treatment is preferable, and as shown in S5 of FIG. 15, an ultraviolet light irradiation treatment using an ultraviolet light irradiation device UV is more preferable. By performing this step, the cholesteric liquid crystalline layer 14 formed by fixing the cholesteric liquid crystalline phase is formed.

In the ultraviolet light irradiation, a light source such as an ultraviolet lamp is used.

An irradiation energy of ultraviolet light is not particularly limited, and is generally preferably approximately 0.1 to 0.8 J/cm². In addition, the time for emitting the ultraviolet light is not particularly limited, and may be suitably determined, from viewpoints of hardness of a cholesteric liquid crystalline layer to be obtained and productivity.

In a case of manufacturing a transmission decorative laminate including a plurality of cholesteric liquid crystalline layers, the steps 1 to 4 may be repeated.

In the above description, as an example of the method of manufacturing the cholesteric liquid crystalline layer, the method of forming a cholesteric liquid crystalline layer including two or more reflection regions having different selective reflection wavelengths due to a difference in exposed amount through a mask, using a photosensitive chiral agent (preferably, chiral agent performing photodegradation) has been described, but the method of manufacturing the cholesteric liquid crystalline layer is not limited thereto, and for example, the following method or the like may be used.

(i) A method of forming a coating using a composition including a liquid crystal compound including a polymerizable group, and a chiral agent sensitive to temperature and capable of changing a helical pitch of a cholesteric liquid crystalline phase, and exposing the coating through a mask, while changing a temperature based on temperature dependency of a helical twisting power (HTP) of the temperature sensitive chiral agent and the liquid crystal compound, to form a cholesteric liquid crystalline layer including two or more regions having different selective reflection wavelengths

(ii) A method of printing two or more kinds of composition for forming a cholesteric liquid crystalline layer having different selective reflection wavelengths (as the composition, the material same as that used in the step 1 is used) on a base material at a regular interval by an ink jet method or a silkscreen method, to form a cholesteric liquid crystalline layer including two or more regions having different selective reflection wavelengths

(iii) A method of transferring a cholesteric liquid crystalline layer manufactured on a transfer substrate by various methods described above, onto a colored transparent base material using an optical pressure sensitive adhesive.

Another member may be disposed on the surface of the transmission decorative laminate of the present invention. For example, a colorless and transparent base material may be disposed on the transmission decorative laminate (particularly, on the base material). With the configuration described above, the colorless and transparent base material functions as a hard-coated layer or a protective layer and a reinforcing effect or a peeling protection effect is obtained.

The material of the colorless and transparent base material is not particularly limited, and the same material as that of the colored transparent base material described above is used.

The “colorless and transparent base material” means a transparent base material which substantially does not perform absorption in a visible light region, and an average transmittance in a wavelength range of 380 to 780 nm is preferably equal to or greater than 80% and more preferably equal to or greater than 90%.

A thickness of the colorless and transparent base material is not particularly limited, and is preferably 10 μm to 5 cm and more preferably 15 μm to 1 cm. The colorless and transparent base material is preferably bonded to the transmission decorative laminate through a commercially available pressure sensitive adhesive.

<Usage>

The usage of the transmission decorative laminate is not particularly limited, and the transmission decorative laminate can be used, for example, as an advertising medium attached to a window glass as window advertisement of a building; a decorative material of an advertising medium attached to a window glass of a car, a taxi, a bus, or a train, or a lighting part of a car, a taxi, a bus, or a train; a traffic sign; a decorative material of a window glass of a house, a store, an aquarium, a zoo, a botanic garden, or a gallery; equipment for a stage or a theater; a decorative material of a transparent member of an elevator, an escalator, or stairs; toys such as a game machine or a card for a game; stationeries such as an underlay for a note; a fashion member of a bag, a cloth, goggles, or sunglasses; or a material of interior fabrics for wall or floor.

In addition to the usage described above, the transmission decorative laminate can also be used as point of purchase advertising (POP), a business card, a sticker, a postcard, a photo, a coaster, a ticket, a tent, a window blind, a shutter, a protective shield, a separator such as a partitioning screen, home appliances (for example, a camera, an instant camera, a personal computer (PC), a smart phone, a television, a recorder, a microwave oven, an audio player, a game machine, a virtual reality (VR) head set, a vacuum cleaner, a washing machine, and the like), a smart phone cover, a case for compact disc (CD) or a DVD, a stuffed toy, a cup, a dish, a plate, a pot, a vase, a desk, a chair, a book, a calendar, a pet bottle, a food packaging container, musical equipment such as a guitar or a piano, sporting goods such as a racket, a bat, a glove, or a ball, attractions of an amusement park such as a maze, a Ferris wheel, a roller coaster, or a ghost house, imitation flower, education toys, a product of a board game, a fan, a folding fan, an umbrella, a cane, a watch, a music box, accessories such as a necklace, a container of cosmetics, or a cover for a solar panel, an electric light, or a lamp.

The transmission decorative laminate may be disposed on a glass base material. That is, this may be used as a glass base material with a transmission decorative laminate including a glass base material and the transmission decorative laminate disposed on the glass base material. Such a glass base material with a transmission decorative laminate may be used as a window glass installed in a building and the like.

### EXAMPLES

Hereinafter, the present invention will be described more specifically with reference to examples and comparative examples. The material, the used amount, the rate, the processing details, and process procedures shown in the following examples can be suitably changed, as long as the gist of the present invention is not departed. Therefore, the scope of the present invention is not limitedly translated by the specific examples shown below.

(Preparation of liquid crystal composition 1)

The components shown below were dissolved in toluene (solid content concentration of 25% by mass), and a liquid crystal composition 1 was prepared.

Liquid crystal compound A: 90 parts by mass

Liquid crystal compound B: 10 parts by mass

Chiral compound a: 11 parts by mass

Surfactant a: 4 parts by mass

Photo-radical initiator a: 3 parts by mass

Polymerization inhibitor: 1 part by mass

Liquid Crystal Compound A (Structure Below)

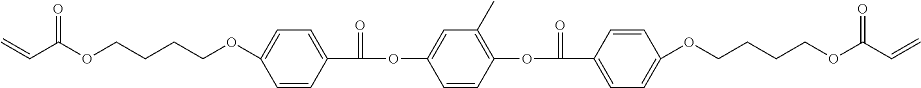 [SMILES: C=CC(=O)OCCCCOc1ccc(C(=O)Oc2ccc(OC(=O)c3ccc(OCCCCOC(=O)C=C)cc3)c(C)c2)cc1]

Liquid Crystal Compound B (Structure Below)

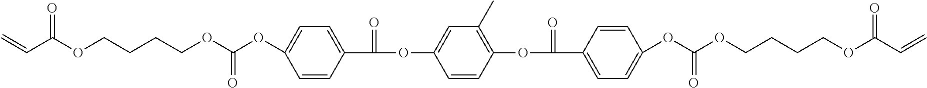 [SMILES: C=CC(=O)OCCCCOC(=O)Oc1ccc(C(=O)Oc2ccc(OC(=O)c3ccc(OC(=O)OCCCCOC(=O)C=C)cc3)c(C)c2)cc1]

Chiral Compound a (Structure Below)

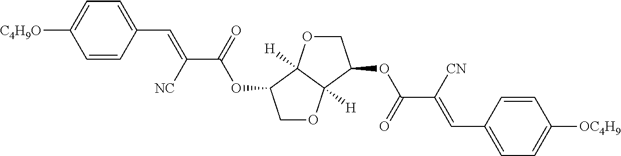

Surfactant a (Structure Below)

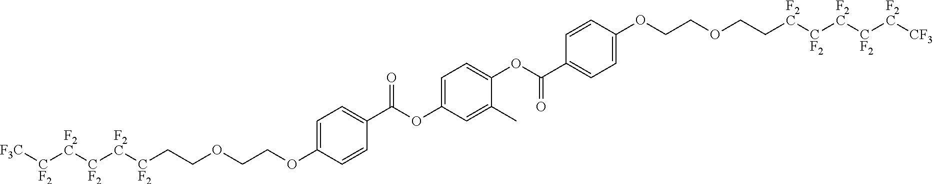 [SMILES: Cc1cc(OC(=O)c2ccc(OCCOCCC(F)(F)C(F)(F)C(F)(F)C(F)(F)C(F)(F)C(F)(F)F)cc2)ccc1OC(=O)c1ccc(OCCOCCC(F)(F)C(F)(F)C(F)(F)C(F)(F)C(F)(F)C(F)(F)F)cc1]

Photo-Radical Initiator a: IRGACURE 819 Manufactured by BASF (Structure Below)

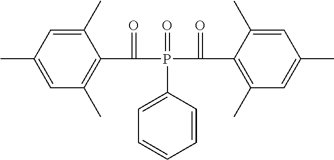

Polymerization Inhibitor: IRGANOX 1010 Manufactured by BASF (Structure Below)

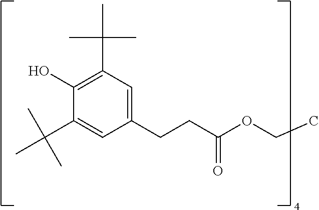

### Example 1

A liquid crystal composition was applied onto a commercially available red transparent color acryl base material (corresponding to the base material 12a described above which absorbs blue light and green light and transmits red light. See FIG. 3) having strong absorption in a wavelength range of 300 to 600 nm at 500 rpm using a spin coater, and a coating was formed.

Next, the exposure at 14 mJ/cm² was performed with respect to the coating, while covering a mask to cover a certain region of the coating, and performing the heating at 30° C. under the air. After that, the exposure at 15 mJ/cm² was performed with respect to the coating, while performing the heating at 30° C. under the air, after removing the mask. Then, the annealing (step of setting the phase in a cholesteric liquid crystalline phase state) of the same base material was performed at 100° C. for 1 minute, and the exposure at 500 mJ/cm² was performed with respect to the coating at room temperature under nitrogen atmosphere (step of forming the cholesteric liquid crystalline layer).

In the obtained transmission decorative laminate, a thickness of the base material is 1 mm and a thickness of the cholesteric liquid crystalline layer is 5 μm.

As a result, in a case where the transmission decorative laminate was observed from the front surface (coated surface) on the cholesteric liquid crystalline layer side as an observation surface, a pattern (green color) having a selective reflection wavelength of 500 nm was visually recognized in a portion where the mask was not covered, and a pattern (blue color) having a selective reflection wavelength of 450 nm was visually recognized in a portion where the mask was covered (corresponding to the observation in the a direction in FIG. 4). That is, in the cholesteric liquid crystalline layer, two or more regions having selective reflection wavelengths different from each other are formed, and a metal gloss tone polychromic image (image having blue and green color tones) could be visually recognized. Meanwhile, in a case where the transmission decorative laminate was observed from the front surface on the base material side as an observation surface, the surface was still red transparent, and an image derived from the cholesteric liquid crystalline layer was not visually recognized (corresponding to the observation in the b direction in FIG. 4).

The scene of the other side could be visually recognized through the transmission decorative laminate, in any observation direction of the front surface and the rear surface described above.

In the red transparent color acryl base material (thickness of 1 mm), both transmittances at wavelengths of 500 nm and 450 nm corresponding to the selective reflection wavelengths of the cholesteric liquid crystalline layer were 30% or less. In addition, the base material also included a region having a transmittance exceeding 30% in a wavelength range of 380 to 780 nm.

### Example 2

The liquid crystal composition 1 was applied onto a commercially available blue transparent color acryl base material (corresponding to the base material 12b described above which absorbs green light and red light and transmits blue light. See FIG. 9) having strong absorption in a wavelength range of 500 to 700 nm at 500 rpm using a spin coater, and a coating was formed.

Next, the exposure at 14 mJ/cm² was performed with respect to the coating, while covering a mask to cover a certain region of the coating, and performing the heating at 30° C. under the air. After that, the exposure at 36 mJ/cm² was performed with respect to the coating, while performing the heating at 30° C. under the air, after removing the mask. Then, the annealing of the same base material was performed at 100° C. for 1 minute, and the exposure at 500 mJ/cm² was performed with respect to the coating at room temperature under nitrogen atmosphere.

In the obtained transmission decorative laminate, a thickness of the base material is 1 mm and a thickness of the cholesteric liquid crystalline layer is 5 μm.

As a result, in a case where the transmission decorative laminate was observed from the front surface (coated surface) on the cholesteric liquid crystalline layer side as an observation surface, a pattern (red color) having a selective reflection wavelength of 600 nm was visually recognized in a portion where the mask was not covered, and a pattern (green color) having a selective reflection wavelength of 550 nm was visually recognized in a portion where the mask was covered. That is, in the cholesteric liquid crystalline layer, two or more reflection regions having selective reflection wavelengths different from each other were formed, and a metal gloss tone polychromic image (image having red and green color tones) could be visually recognized (corresponding to the observation in the a direction in FIG. 10). Meanwhile, in a case where the transmission decorative laminate was observed from the base material side as an observation surface, the surface was still blue transparent, and an image derived from the cholesteric liquid crystalline layer was not visually recognized (corresponding to the observation in the b direction in FIG. 10).

The scene of the other side could be visually recognized through the transmission decorative laminate, in any observation direction of the front surface and the rear surface described above.

In the blue transparent color acryl base material (thickness of 1 mm) used in Example 2, both transmittances at wavelengths of 600 nm and 550 nm corresponding to the selective reflection wavelengths of the cholesteric liquid crystalline layer were 30% or less. In addition, the base material also included a region having a transmittance exceeding 30% in a wavelength range of 380 to 780 nm.

### Example 3

The liquid crystal composition 1 was applied onto a PET (polyethylene terephthalate) base material having a thickness of 50 μm using a coating bar No. 12 to have a constant film thickness, and a coating was formed.

Next, the exposure at 35 mJ/cm² was performed with respect to the coating, while covering a mask to cover a certain region of the coating, and performing the heating at 30° C. under the air. After that, the exposure at 15 mJ/cm² was performed with respect to the coating, while performing the heating at 30° C. under the air, after removing the mask. Then, the annealing of the same base material was performed at 100° C. for 1 minute, and the exposure at 500 mJ/cm² was performed with respect to the coating at room temperature under nitrogen atmosphere.

As a result, in a case where the laminate was observed from the front surface (coated surface) on the cholesteric liquid crystalline layer side as an observation surface, a pattern (red color) having a selective reflection wavelength of 650 nm was visually recognized in a portion where the mask was not covered, and a pattern (blue light) having a selective reflection wavelength of 450 nm was visually recognized in a portion where the mask was covered. That is, in the cholesteric liquid crystalline layer, two or more regions having selective reflection wavelengths different from each other were formed, and a metal gloss tone polychromic image (image having red and blue color tones) could be visually recognized. The cholesteric liquid crystalline layer of this laminate was transferred to commercially available green transparent color cellophane (corresponding to the base material 12c described above which absorbs blue light and red light and transmits green light. See FIG. 13) having strong absorption in a wavelength range of 300 to 500 nm and 600 to 700 nm using an optical pressure sensitive adhesive.

In the obtained transmission decorative laminate, a thickness of the base material is m and a thickness of the cholesteric liquid crystalline layer is 5 μm.

As a result, in a case where the transmission decorative laminate was observed from the front surface (transferred surface) on the cholesteric liquid crystalline layer side as an observation surface, the reflected light having a clearer structural color than that in a case of being observed on the PET film, was visually recognized, whereas, in a case where the transmission decorative laminate was observed from the front surface on the base material side (color cellophane side) as an observation surface, the surface was still transparent and an image derived from the cholesteric liquid crystalline layer could not be visually recognized.

In the green transparent color acryl base material (thickness of 20 μm) used in Example 3, both transmittances at wavelengths of 650 nm and 450 nm corresponding to the selective reflection wavelengths of the cholesteric liquid crystalline layer were 30% or less. In addition, the base material also included a region having a transmittance exceeding 30% in a wavelength range of 380 to 780 nm.

### Comparative Example 1

The liquid crystal composition 1 was applied onto a commercially available yellow transparent color acryl base material having strong absorption in a wavelength range of 300 to 500 nm at 500 rpm using a spin coater, and a coating was formed.

Next, the exposure at 14 mJ/cm² was performed with respect to the coating, while covering a mask to cover a certain region of the coating, and performing the heating at 30° C. under the air. After that, the exposure at 36 mJ/cm² was performed with respect to the coating, while performing the heating at 30° C. under the air, after removing the mask. Then, the annealing of the same base material was performed at 100° C. for 1 minute, and the exposure at 500 mJ/cm² was performed with respect to the coating at room temperature under nitrogen atmosphere.

In the obtained transmission decorative laminate, a thickness of the base material is 1 mm and a thickness of the cholesteric liquid crystalline layer is 5 μm.

As a result, in a case where the transmission decorative laminate was observed from the front surface (coated surface) on the cholesteric liquid crystalline layer side as an observation surface, a pattern (red color) having a selective reflection wavelength of 600 nm was visually recognized in a portion where the mask was not covered, and a pattern (green color) having a selective reflection wavelength of 550 nm was visually recognized in a portion where the mask was covered. That is, in the cholesteric liquid crystalline layer, two or more regions having selective reflection wavelengths different from each other were formed, and a metal gloss tone polychromic image (image having red and green color tones) could be visually recognized. Meanwhile, in a case where the transmission decorative laminate was observed from the base material side as an observation surface, light leakage of green light and red light occurred, and an image derived from the cholesteric liquid crystalline layer was visually recognized.

In the yellow transparent color acryl base material (thickness of 1 mm) used in Comparative Example 1, both transmittances at wavelengths of 600 nm and 550 nm corresponding to the selective reflection wavelengths of the cholesteric liquid crystalline layer were more than 90%, and an absorption peak was not substantially provided at the wavelength thereof.

### EXPLANATION OF REFERENCES

10a, 10b, 10c: transmission decorative laminate
12a, 12b, 12c: colored transparent base material
13a: coating
13b: partially exposed coating
13c: entirely exposed coating
13d: coating in state of cholesteric liquid crystalline phase
14: cholesteric liquid crystalline layer formed by fixing cholesteric liquid crystalline phase
14a, 14b, 14c: cholesteric liquid crystalline layer
14rR: red right circular polarization reflection region
14rG: green right circular polarization reflection region
14rB: blue right circular polarization reflection region
S: light source
H: heater
UV ultraviolet light irradiation device

What is claimed is:

1. A transmission decorative laminate comprising:
a colored transparent base material; and
a cholesteric liquid crystalline layer disposed on the base material,
wherein the cholesteric liquid crystalline layer includes two or more reflection regions having different selective reflection wavelengths, and
the base material absorbs light at wavelengths which are the same as selective reflection wavelengths of two or more reflection regions.

2. The transmission decorative laminate according to claim 1,
wherein each of transmittances of the base material at the selective reflection wavelengths in the two or more reflection regions are all 30% or less.

3. The transmission decorative laminate according to claim 1,
wherein the base material includes a region having a transmittance exceeding 30% in a wavelength range of 380 to 780 nm.

4. The transmission decorative laminate according to claim 1,
wherein the selective reflection wavelengths of the two or more reflection regions are different from each other by 30 nm or more.

5. The transmission decorative laminate according to claim 1, which is used for an advertising medium.

6. A glass base material with a transmission decorative laminate, the glass base material comprising:
a glass base material; and
the transmission decorative laminate according to claim 1 which is disposed on the glass base material.

7. The glass base material with a transmission decorative laminate according to claim 6, which is used for a window glass.

8. A method of manufacturing the transmission decorative laminate according to claim 1, the method comprising:
a step of forming a coating using a liquid crystal composition including a liquid crystal compound including a polymerizable group, and a chiral agent sensitive to light and capable of changing a helical pitch of a cholesteric liquid crystalline phase;
a step of performing an exposure treatment on the coating in a pattern shape, with light to which the chiral agent is sensitive;
a step of performing a heating treatment on the coating subjected to the exposure treatment and aligning the liquid crystal compound to be in a state of a cholesteric liquid crystalline phase; and
a step of performing a curing treatment on the coating subjected to the heating treatment and forming the cholesteric liquid crystalline layer formed by fixing the cholesteric liquid crystalline phase.

9. The transmission decorative laminate according to claim 2,
wherein the base material includes a region having a transmittance exceeding 30% in a wavelength range of 380 to 780 nm.

10. The transmission decorative laminate according to claim 2,
wherein the selective reflection wavelengths of the two or more reflection regions are different from each other by 30 nm or more.

11. The transmission decorative laminate according to claim 3,
wherein the selective reflection wavelengths of the two or more reflection regions are different from each other by 30 nm or more.

12. A glass base material with a transmission decorative laminate, the glass base material comprising:
a glass base material; and
the transmission decorative laminate according to claim 2 which is disposed on the glass base material.

13. A glass base material with a transmission decorative laminate, the glass base material comprising:
a glass base material; and
the transmission decorative laminate according to claim 3 which is disposed on the glass base material.

14. A glass base material with a transmission decorative laminate, the glass base material comprising:
a glass base material; and
the transmission decorative laminate according to claim 4 which is disposed on the glass base material.
